(19) United States
(12) Patent Application Publication
(10) Pub. No.: US 2010/0172033 A1
(43) Pub. Date: Jul. 8, 2010

(54) KEYPAD SECURITY DEVICE

(76) Inventor: Neil Radford, West Midlands (GB)

Correspondence Address: NEXSEN PRUET, LLC, P.O. BOX 10648, GREENVILLE, SC, 29603, US

(21) Appl. No.: 12/294,803

(22) PCT Filed: Mar. 28, 2007
(86) PCT No.: PCT/GB2007/001118

§ 371 Date: Oct. 27, 2008

(30) Foreign Application Priority Data
Mar. 28, 2006 (GB) 0606208.7
Oct. 2, 2006 (GB) 0619423.7

(51) Int. Cl. G02B 27/02; G02B 3/08

(52) U.S. Cl. 359/743; 359/810; 359/804

(57) ABSTRACT

A keypad security device (100) comprises an enclosure having a viewing aperture (114) and an access aperture (152). The enclosure at least partially surrounds a keypad such that the keypad is viewable through the viewing aperture (114) and accessible by a user through the access aperture (152). The viewing aperture includes a security pane (116) arranged so as to permit the keypad to be viewed clearly from the point of view of a user of the keypad and to prevent the keypad from being viewed from the point of view of a person other than the user, wherein the security pane (116) is curved and comprises a flexible refractive lens.

The present invention relates to data entry keypad security and in particular, though not exclusively, to the security of data entry keypads fitted to ATMs (Automated Teller Machines), retail Chip and PIN (Personal Identification Number) EPOS (Electronic Point Of Sale) systems and PEDs (PIN Entry Devices).

In recent years there has been an increase in crime related to the fraudulent use of cash cards to withdraw money from ATMs. In order to perpetrate such a crime a criminal will usually need obtain details of a legitimate users cash card together with the PIN needed to activate the card. Obtaining the PIN may be achieved in a number of ways when a legitimate user uses an ATM. A criminal may simply stand close to the user and observe the user keying in their PIN, a practice commonly referred to as shoulder surfing. More sophisticated methods of obtaining PINs involve the positioning of a camera in the vicinity of an ATM which is able to view the keypad. Similar security concerns exist at point of sale PIN entry devices which are increasingly common in the retail environment.

According to the present invention there is provided a keypad security device comprising an enclosure having a viewing aperture and an access aperture, the enclosure at least partially surrounding a keypad such that the keypad is viewable through the viewing aperture and accessible by a user through the access aperture, the viewing aperture including a security pane arranged so as to permit the keypad to be viewed clearly from the point of view of a user of the keypad and to prevent the keypad from being viewed from the point of view of a person other than the user, wherein the security pane includes a refractive lens.

According to another aspect of the present invention there is provided a keypad security device comprising an enclosure having a viewing aperture and an access aperture, the enclosure at least partially surrounding a keypad such that the keypad is viewable through the viewing aperture and accessible by a user through the access aperture, the viewing aperture including a security pane arranged so as to permit the keypad to be viewed clearly from the point of view of a user of the keypad and to prevent the keypad from being viewed from the point of view of a person other than the user, wherein the security pane includes a refractive lens, and the security pane is inclined relative to the keypad.

According to a further aspect of the present invention there is provided a keypad security device comprising an enclosure having a viewing aperture and an access aperture, the enclosure at least partially surrounding a keypad such that the keypad is viewable through the viewing aperture and accessible by a user through the access aperture, the viewing aperture including a security pane arranged so as to permit the keypad to be viewed clearly from the point of view of a user of the keypad and to prevent the keypad from being viewed from the point of view of a person other than the user, wherein the security pane is curved and comprises a flexible refractive lens.

By curving the security pane, problems associated with glare from, for example light sources around or above the device are reduced. The pane is curved outwardly with respect to the keypad. In a preferred embodiment, the pane is curved about an axis which lies laterally with respect to the orientation of the keypad. The radius of curvature of the security pane may be in the range of 100 mm to 500 mm. More specifically, the radius of curvature may be in the region of 100 mm to 200 mm. The radius of curvature may be in the region if 110 mm to 150 mm. The curving of the security pane furthermore provides better hand access for the user and reduces the possibility of the user contacting the security pane with their knuckles.

The keypad enclosure shields the keypad and prevents the keystrokes made by the user from being observed. The security pane enables a user to observe the keypad both before and during use but prevents a person standing close to the user from observing the keystrokes made by the user through the security pane. The security pane also prevents the keystrokes made by the user from being observed remotely, for example by a camera positioned outside of the enclosure in the vicinity of the keypad.

The security pane is positioned in the viewing aperture such that a viewing axis extends therethrough to the keypad. A person aligning themselves with the viewing axis so as to view the keypad along the axis is able to view the keypad in a clear manner. Should an attempt be made to view the keypad through the security pane along an axis other than the viewing axis, then the security pane either partially or wholly distorts and/or obscures the view of the keypad. The viewing axis may be substantially perpendicular to the security pane. The viewing axis may be substantially perpendicular to the security pane and the keypad. The security pane may be provided with a plurality of viewing axes along which the keypad may be viewed in a clear and undistorted or unobscured manner. Such a plurality of axes may define a viewing corridor through which the keypad may be viewed clearly.

In one embodiment the security pane may comprise a lens which in use alters the view of the keypad observed by a user when viewing the keypad through the pane. In a preferred embodiment the lens is a magnifying lens. The lens preferably has the ability to both magnify or distort what is viewed therethrough depending upon the angle of the line of sight through which the lens is viewed. The lens preferably has a refractive index of between 1.3 and 1.8. More preferably the lens has a refractive index of between 1.4 and 1.7. The lens may have a refractive index of between 1.45 and 1.65, or, alternatively, have a refractive index of between 1.47 and 1.61. In one embodiment the lens may be manufactured from acrylic and have a refractive index of between 1.47 and 1.51. Alternatively, the lens may manufactured from vinyl chloride and have a refractive index of between 1.52 and 1.56. In a further embodiment the lens may be manufactured from polyethylene and have a refractive index of between 1.49 and 1.53. In yet a further embodiment the lens may be manufactured from polycarbonate and have a refractive index of between 1.57 and 1.61. In yet a further embodiment, the lens may be manufactured from a polyorganosiloxane material and have a refractive index of between 1.2 and 1.8.

The lens may be a fresnel lens or the like. The term fresnel lens is intended to cover lenses which utilise a texture applied to the surface thereof to achieve desired image alteration characteristics. The fresnel lens is formed by a the provision of a plurality of concentric grooves upon a sheet or plate of transparent material. The pitch of the grooves of the lens may be in the range of 0.01 mm to 0.06 mm. The pitch of the grooves may be in the range of 0.02 mm to 0.05 mm. In a preferred embodiment, the grooves of the lens may have a pitch of around 0.04 mm. It will be appreciated that the pitch of the grooves will depend upon the desired magnification and clarity of the lens. It will be understood that the finer groove the pitch then the a clearer the magnified image. On the other hand, a coarser groove pitch provides better magnification at the expense of image clarity.

The texture may enhance and/or complement image alteration characteristics of a lens which result from the shape of the lens. The pane may be provided with a plurality of lenses each of which may be aligned with one or more of the keys of the keypad. The security pane may include an image which permits the keypad to be viewed therethrough along the viewing axis or corridor but which obscures the keypad when viewed along an axis not aligned with the viewing axis of falling within the viewing corridor. The image may be provided on or in the security pane. For example the image may be etched or otherwise applied to a surface of the security pane. Alternatively the image may be embedded within the security pane. In such an embodiment the image may be a holographic image.

The lens may have a thickness of between 0.4 mm to 5 mm. Where the lens is intended to be flexible, for example where the lens is curved, the lens may have a thickness of between 0.4 mm and 1.5 mm. In such an embodiment the lens may preferably have a thickness which is in the region of 1 mm. Where the lens or security pane is intended to be rigid, the leans or security pane may have a thickness of around 5 mm.

The security pane may comprise a unitary member comprised of a plastics material such as polycarbonate or a vitreous material such as glass. The security pane may be of laminar construction. In such an embodiment the pane may comprises upper and lower planar members between which is located the lens. The planar members may have substantially the same shape as one another and the lens. The pane may be incorporated in the enclosure during the manufacture thereof, for example the pane may be incorporated into the enclosure during moulding of the enclosure from a plastics material. Alternatively, the security pane may be removable from the enclosure. The pane is thus able to be replaced if, for example, it becomes damaged or scratched.

The enclosure may comprise a wall arranged so as to at least partially surround the keypad. The enclosure may alternatively comprise a plurality of walls arranged so as to at least partially surround the keypad. The access aperture may by defined by an aperture provided in the wall or one of the plurality of walls. Alternatively the access aperture may be defined by a gap or space provided between two walls. The or each wall may be provided with a window arranged so as to permit light to enter the enclosure while preventing the keypad to be viewed therethrough. The window preferably includes glazing pane which is translucent, frosted, opaque or otherwise treated so as to prevent the keypad to be viewed therethrough. The or each wall may be a wall of a base to which a keypad is attached or mounted. In such an instance the security pane may be contained within a member which is mountable to the or each wall.

The enclosure may be provided with an additional access aperture. In use, the additional access aperture may be aligned with a feature of a device to which the keypad is fitted. For example the additional access aperture may be aligned with a banknote dispensing slot of an ATM. The presence of the additional access aperture permits a user to reach the banknote dispensing slot through the enclosure. It will thus be appreciated that the enclosure may provide a shielding function for the dispensing slot to prevent unauthorised access to banknotes dispensed therethrough. Preferably the additional access aperture is provided on an opposite side of the enclosure to the keypad access aperture to allow a user to easily reach through the enclosure.

The viewing aperture is preferably provided in a portion of the enclosure overlying the wall or walls. Preferably the viewing aperture is aligned with a plane which is substantially parallel to the plane of the keypad.

According to a further aspect of the present invention there is provided a keypad security device comprising an enclosure having a viewing aperture and an access aperture, the enclosure at least partially surrounding a keypad such that the keypad is viewable through the viewing aperture and accessible by a user through the access aperture, the viewing aperture including a security pane arranged so as to permit the keypad to be viewed clearly from the point of view of a user of the keypad and to prevent the keypad from being viewed from the point of view of a person other than the user, wherein the security pane includes a refractive lens and the security pane is pivotably mounted to the enclosure.

In such an embodiment the security pane may be pivotable between an operative position whereupon it overlies the keypad, and a non-operative position whereupon the pane does not overlie the keypad. The security pane may be carried by a visor which is pivotably mounted to the enclosure. Preferably, the visor is arranged so as to provide the security pane in a curved orientation.

By curving the security pane, problems associated with glare from, for example light sources around or above the device are reduced. The pane is curved outwardly with respect to the keypad. In a preferred embodiment, the pane is curved about an axis which lies laterally with respect to the orientation of the keypad. The radius of curvature of the security pane may be in the range of 100 mm to 500 mm. More specifically, the radius of curvature may be in the region of 100 mm to 200 mm. The radius of curvature may be in the region if 110 mm to 150 mm. The curving of the security pane furthermore provides better hand access for the user and reduces the possibility of the user contacting the security pane with their knuckles.

Embodiments of the present invention will now be described with reference to the accompanying drawings in which:

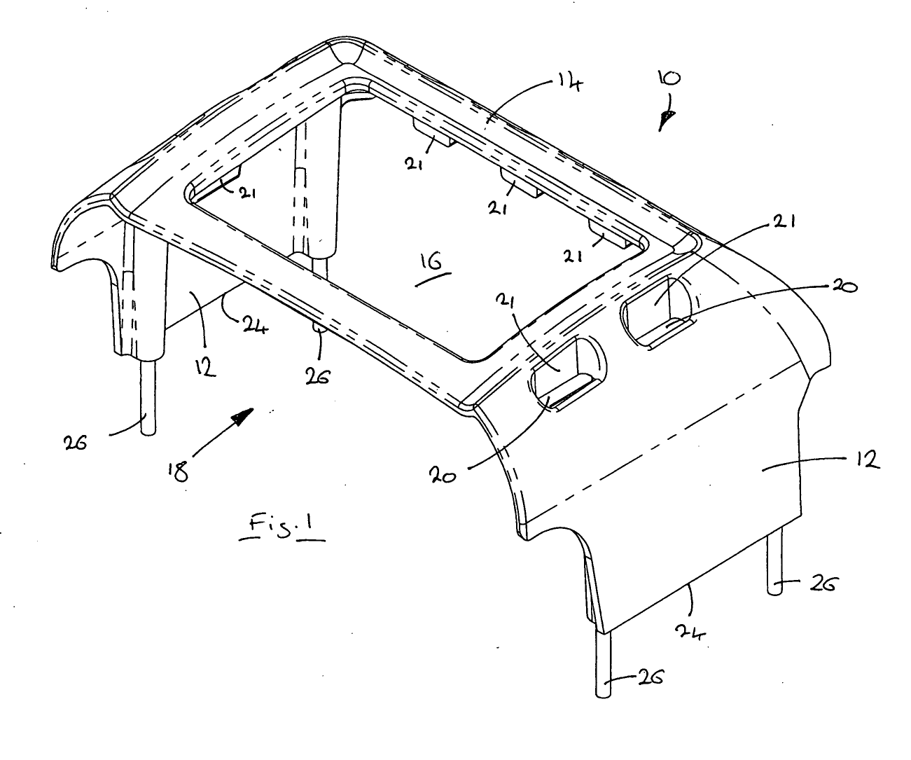

FIG. 1 is a perspective view from above and to one side of a security enclosure device according to the present invention;

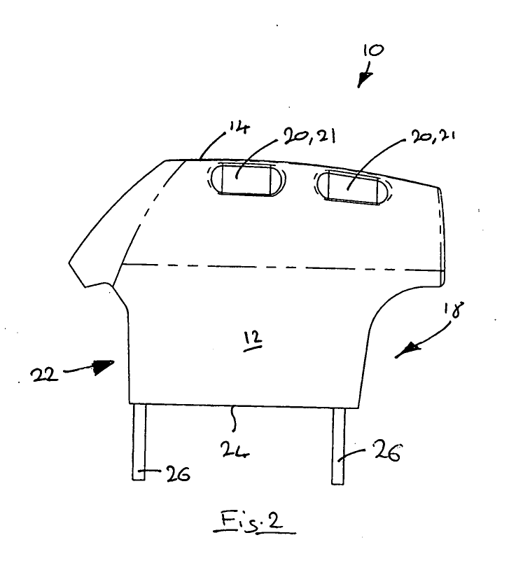

FIG. 2 is a side view of the device of FIG. 1;

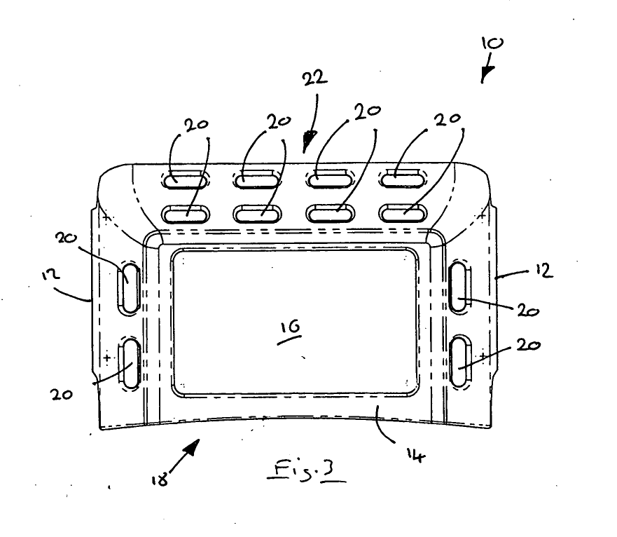

FIG. 3 is a top plan view of the device of FIG. 1;

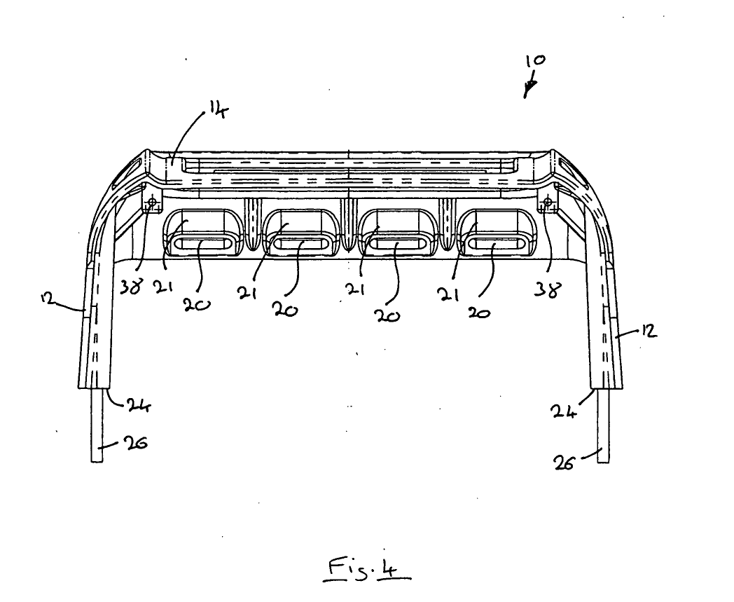

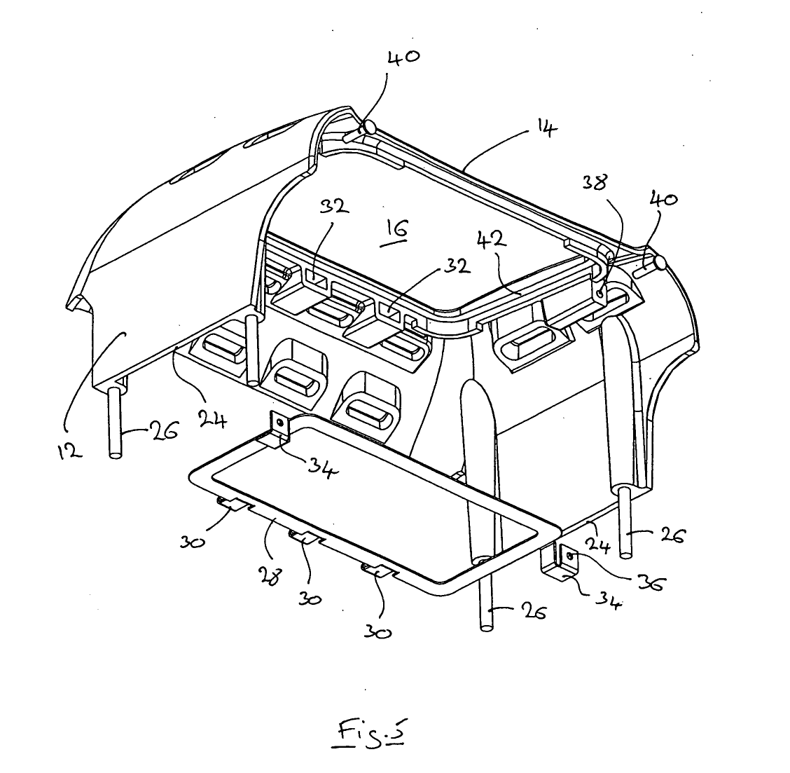

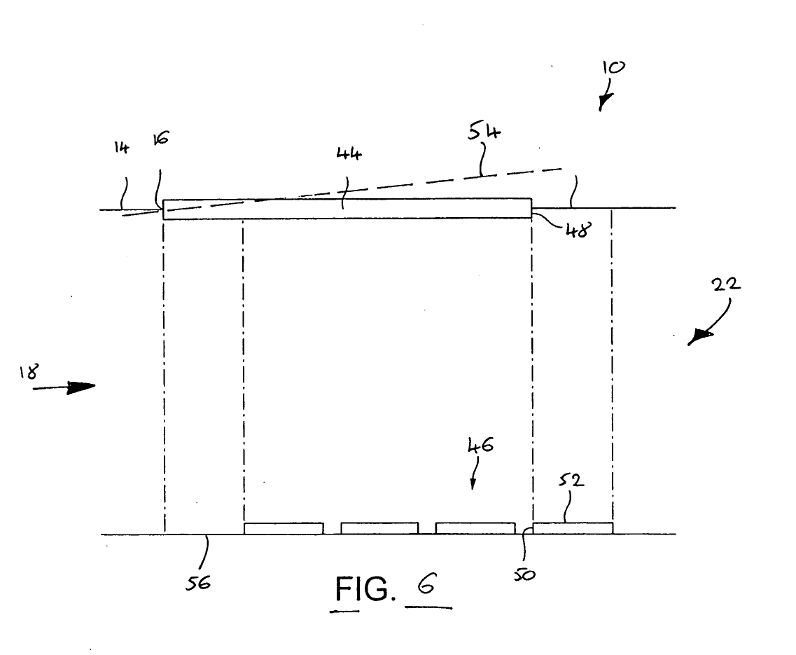

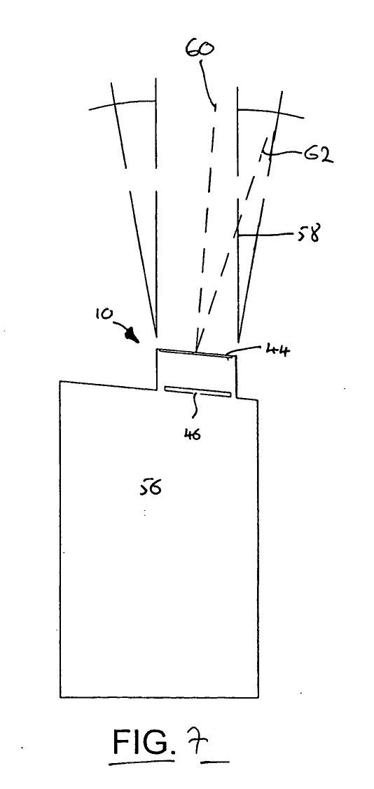

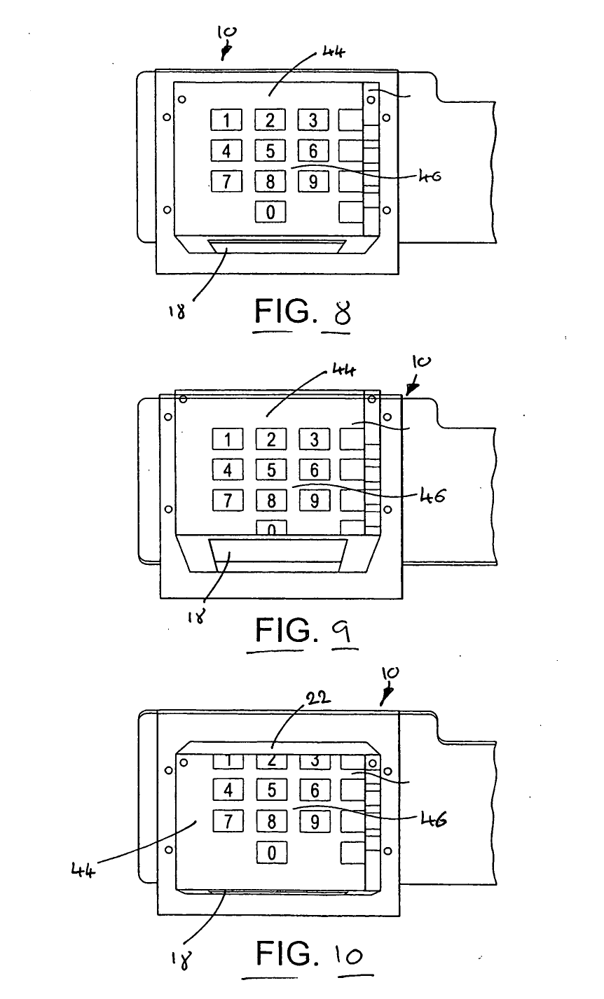

FIG. 4 is a rear view of the device of FIG. 1;

FIG. 5 is a perspective view from below and to one side of the device of FIG. 1 with a lens carrier removed;

FIG. 6 shows a side view of the alignment of a security pane of the device of FIG. 1 with a keypad;

FIGS. 7 to 10 show views of a keypad through the security pane of the device;

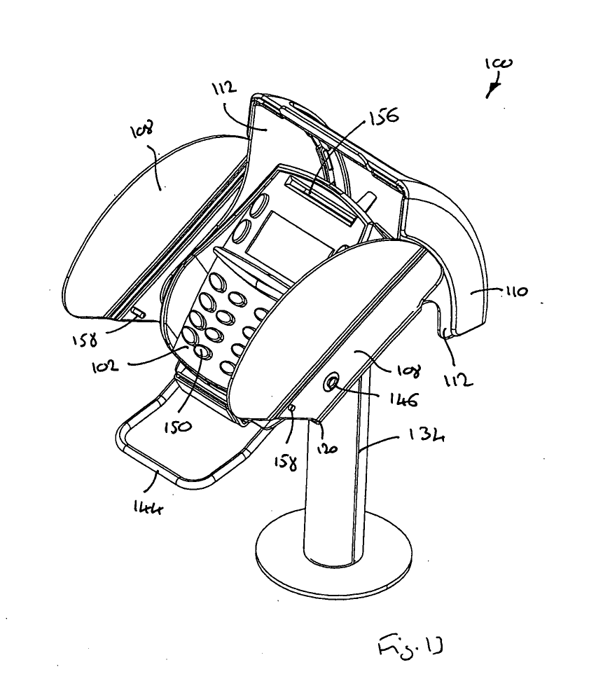

FIG. 11 is a perspective view from above and to one side of an alternative security enclosure device according to the present invention with a visor of the device retracted;

FIG. 12 is a perspective view of the device of FIG. 11 with the visor deployed;

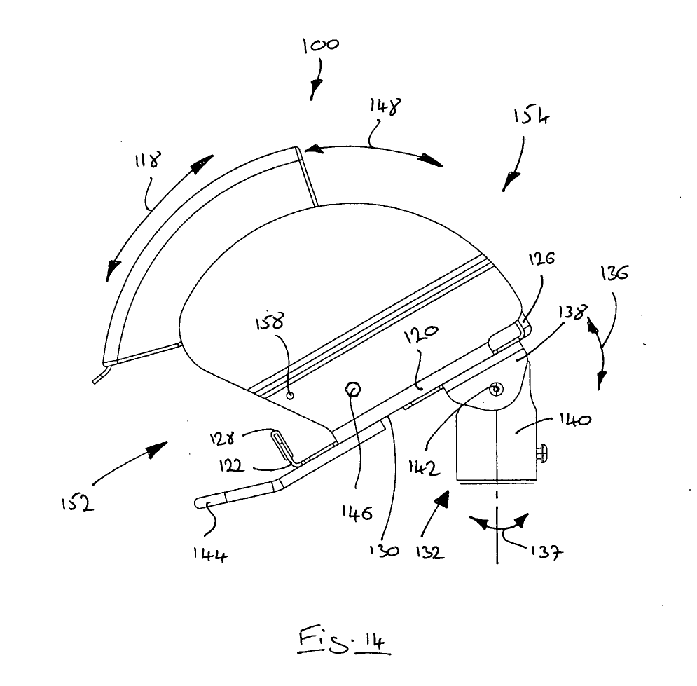

FIG. 13 is a further perspective view of the device of FIG. 11 with a keypad attached;

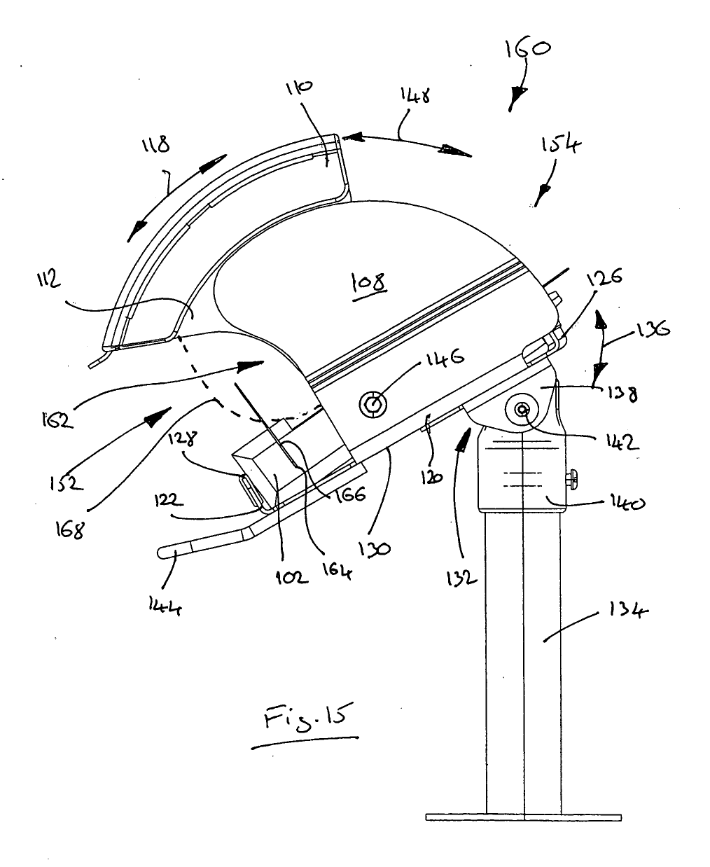

FIG. 14 is a side view of the device of FIG. 11;

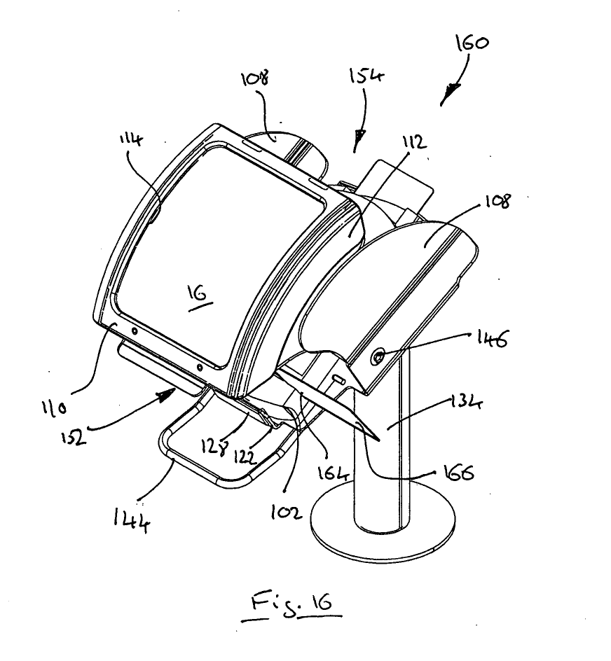

FIG. 15 is a perspective view from above and to one side of an further security enclosure device according to the present invention;

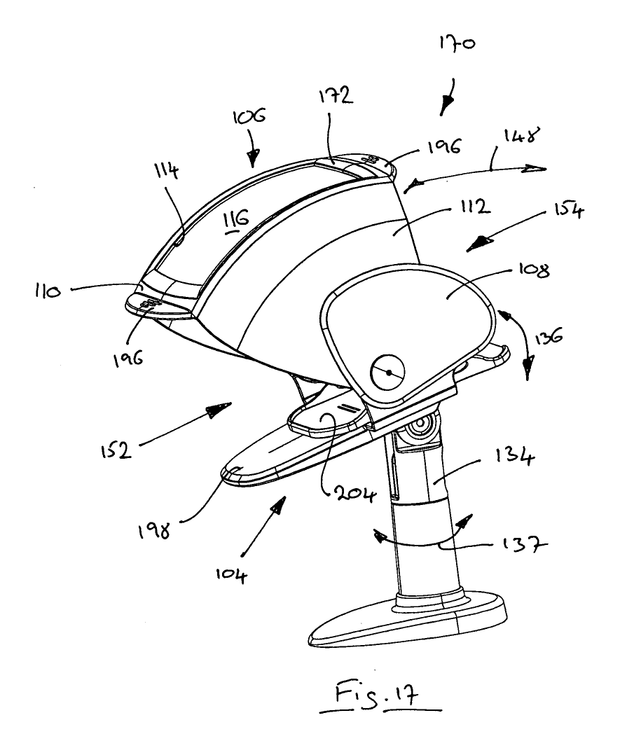

FIG. 16 is a side view of the security enclosure of FIG. 15;

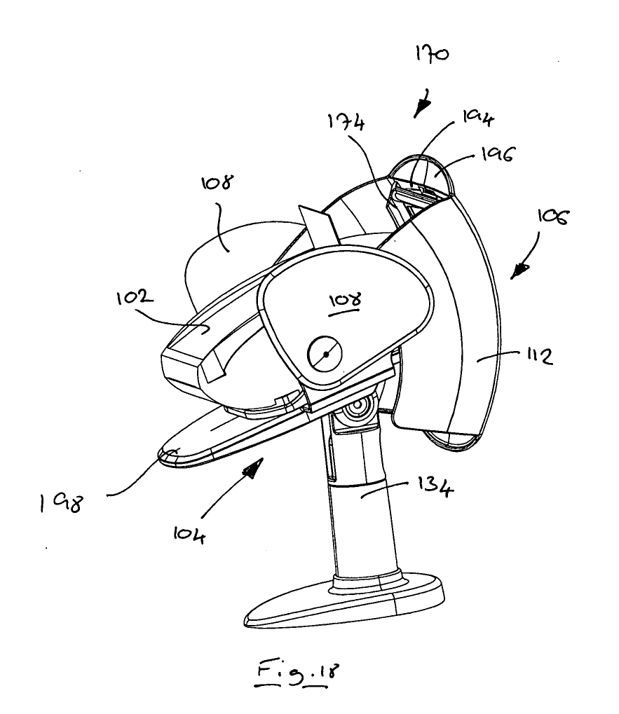

FIG. 17 is a perspective view from above and to one side of a further alternative security enclosure device according to the present invention with a visor of the device deployed;

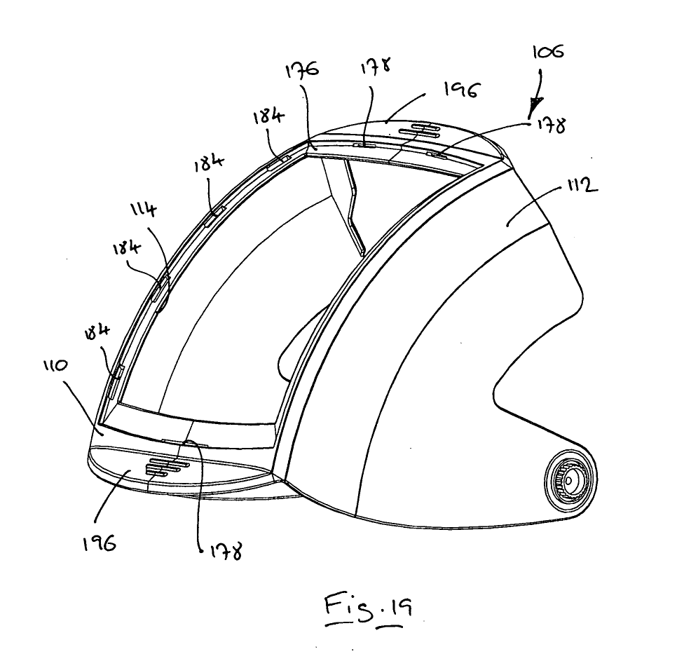

FIG. 18 is a perspective view from above and to one side of the security enclosure device of FIG. 17 with a FED unit in place and the visor retracted;

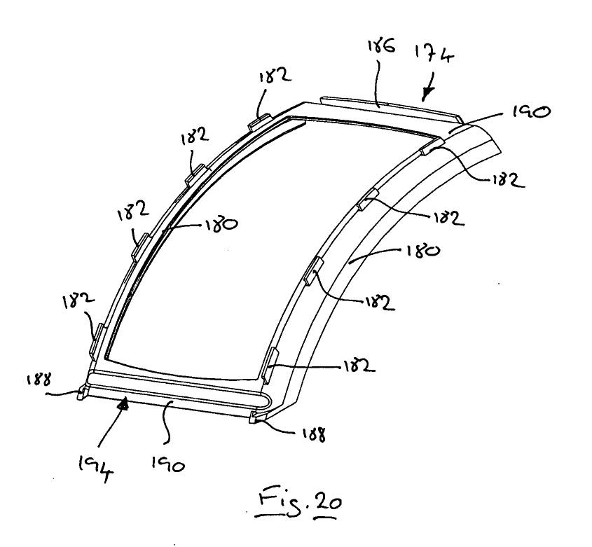

FIG. 19 is a perspective view of the visor of the security enclosure device of FIG. 17 without the inner and outer bezels or lens fitted.

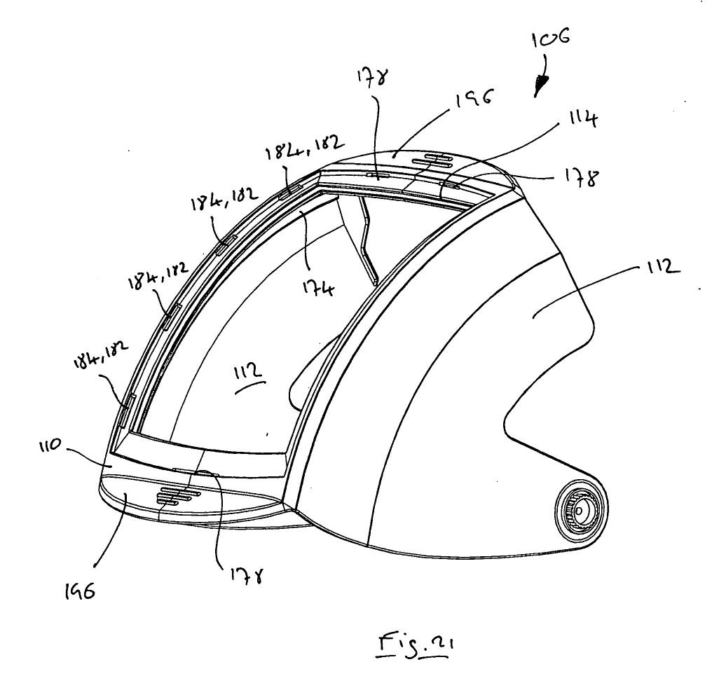

FIG. 20 is a perspective view of an inner visor bezel of the security enclosure device of FIG. 17;

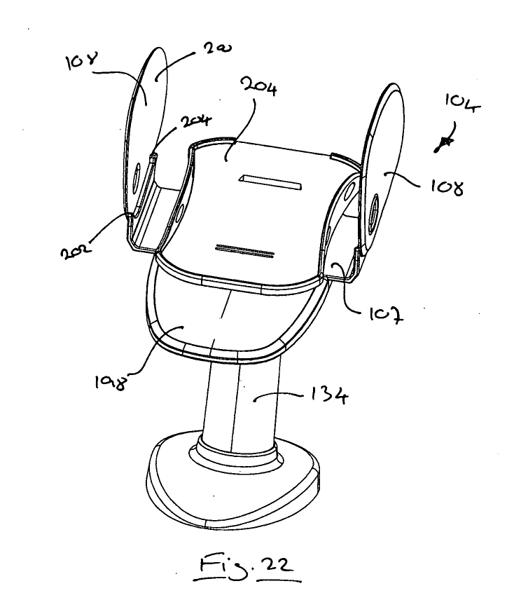

FIG. 21 is a perspective view of the visor of the security enclosure device of FIG. 17 with the inner bezel fitted;

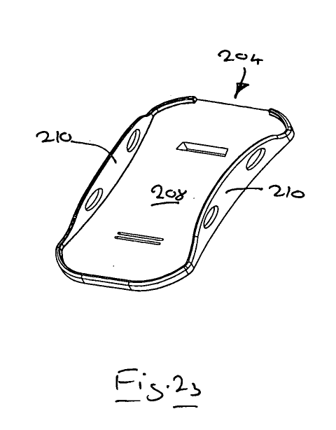

FIG. 22 is a perspective view from the front and above of the base, PED unit plate and mounting post of the security enclosure device of FIG. 17;

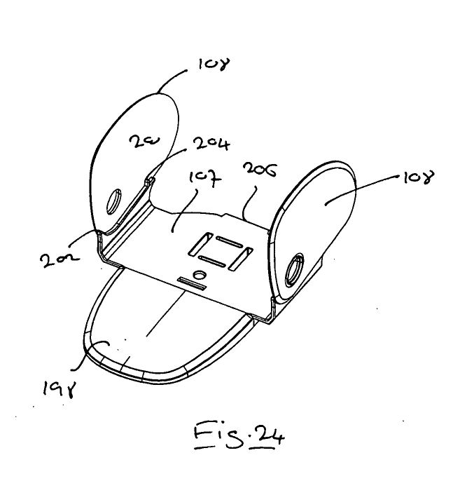

FIG. 23 is a perspective view from the front and above of the PED unit plate of the security enclosure device of FIG. 17; and

FIG. 24 is a perspective view from the front and above of the base of the security enclosure device of FIG. 17.

Referring firstly to FIGS. 1 to 5 there is shown a security enclosure device according to the present invention and generally designated 10. The enclosure device 10 is configured for use with a keypad of an ATM. The enclosure device 10 comprises an enclosure having a pair of spaced side walls 12 joined by a bridging portion 14. Within the bridging portion 14 there is provided a viewing aperture 16 into which a security pane (not shown) may be retained. The walls 12 and bridging portion 14 define an access aperture 18 into which a user may place their hand when the enclosure is fitted over a keypad. The enclosure device 10 may be manufactured as a single piece item from a toughened plastics material by a moulding operation. Alternatively, the enclosure device 10 may be manufactured from metal such as aluminum alloy by a casting operation. The security pane may be incorporated into the enclosure during moulding thereof. Alternatively the security pane may be retrofitted to the enclosure after it has been manufactured.

The enclosure device 10 is further provided with a plurality of spaced holes 20 around the viewing aperture 16. The holes 20 let light into the space surrounded by the enclosure device 10 while not permitting the keypad to be directly viewed therethrough. Each hole 20 is at least partially defined by a wall or tubular extension 21 which extends into the interior of the enclosure 10 to prevent the ATM keypad being viewed therethrough.

It will be appreciated that the walls 12 and bridging portion 14 define another additional access aperture 22 on the opposite side of the enclosure device 10 to the first aperture 18. On certain configurations of ATM the slot through which bank notes are dispensed is positioned in front of and slightly above the keypad. In such a configuration a user is able to take the bank notes dispensed with the same hand as that used to input their PIN to the keypad. The provision of the additional access aperture 22 enables a user to reach the banknotes while the enclosure device 10 as a whole shields the slot through which they are dispensed and thus prevents them from being snatched by a person other than the user of the ATM.

The enclosure device 10 may be moulded from a translucent plastics material which permits a degree of light transmission therethrough while at the same time not permitting the keypad to be viewed through the walls 12 and bridging portion 14 surrounding the viewing aperture 16. The translucent nature of the plastics material enables a user or operator of the ATM to readily see if anything, such as a miniature camera, has been attached to the inner surface of the enclosure. The inner surfaces of the enclosure may additionally be textured so as make it difficult for a device such as a miniature camera to be attached thereto. For example, the inner surfaces of the enclosure may be ribbed or ridged.

The enclosure device 10 may be mounted to the ATM by any appropriate fixing means. In the embodiment shown the lower edge 24 of each wall 12 is provided with projections 26 which extend through corresponding apertures of the ATM. The projections 26 may be threaded so as to receive nuts thereupon. Alternatively, the lower edge 24 of each wall 12 may be provided with a flange through which appropriate fixing means may extend.

FIG. 5 shows a mounting frame 28 which is finable to the enclosure device 10 to retain a security pane in the viewing aperture 16. The frame 28 corresponds substantially to the shape of the viewing aperture 16. The frame 28 is provided with a plurality of projections 30 which are receivable in complementary recesses 32 provided within the enclosure device 10. The frame 28 is further provided with a pair of extensions 34 each of which is provided with an aperture 36. When the frame 28 is in position around the viewing aperture 16, the extension apertures 36 align with fastener apertures 38 of the enclosure device 10. The frame 28 is retained in place by the provision of threaded fasteners 40 extending through the apertures 36,38, with the security pane being retained between the frame 28 and a lip 42 extending around the viewing aperture 16 on the interior side of the enclosure device 10.

The presence of the frame 28 ensures that it is relatively simple for the security pane to be removed and replaced in the event that the pane becomes damaged or broken. In a preferred embodiment the threaded fasteners have a non-standard head configuration, which is to say a configuration other than a slot, Philips or hex configuration, so as to prevent the unauthorised removal of the frame 28 and security pane.

The enclosure device 10 may be mounted to the ATM such that the viewing aperture 16 and security pane 44 are not fully in register with the ATM keypad 46. FIG. 6 shows an example of such an alignment between the viewing aperture 16, security pane 44 and keypad 46. The upper edge 48 of the viewing aperture 16 and security pane 44 is aligned with the lower edge 50 of the upper row of keys 52 of the keypad 46. This out of register alignment ensures that a user of the ATM keypad 46 is able to fully view the keypad 46 through the security pane 44, while persons attempting to view the keypad 46 from positions other than that corresponding to the point of view of the user, either over the shoulder of the user or remotely via a camera mounted above or near the ATM, are unable to view the full keypad 46 through the security pane 44. The viewing aperture 16 and security pane 44 may be inclined relative to the keypad 46 as indicated by broken line 54. In the embodiment shown the viewing aperture 16 and security pane 44 are inclined at an angle of around 4 degrees relative to the keypad 46. The inclination is such the edge 48 of the viewing aperture 16 and security pane 44 which, in use, is furthest away from the user is higher than edge which is closest to the user.

The viewing aperture 16 and security pane 44 be inclined or offset with respect to the keypad 46. Alternatively, the viewing aperture 16 and security pane 44 may be both inclined and offset with respect to the keypad 46. In yet an alternative embodiment, the security pane 44 alone may be inclined with respect to the keypad.

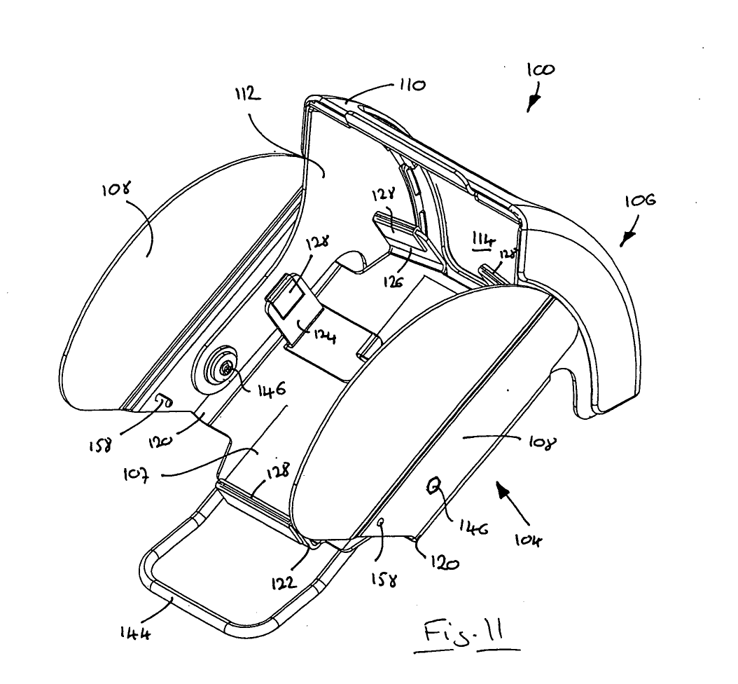

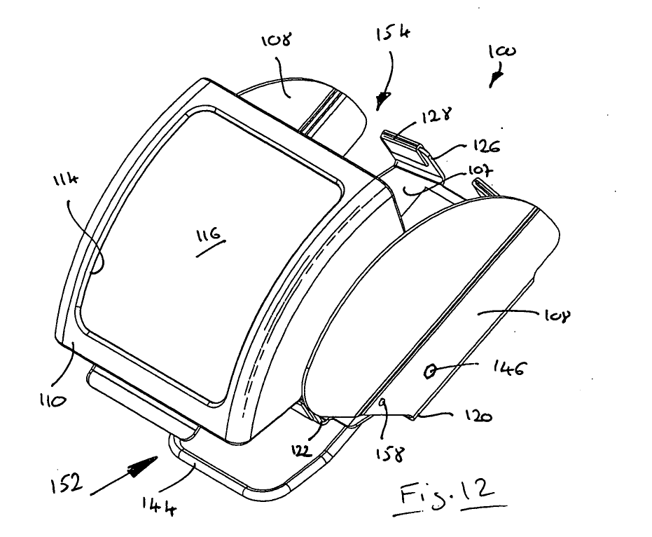

As described above the security pane 44 is arranged such that the keypad 46 may be clearly viewed from certain viewing positions while being prevented from being viewed from other positions. The security pane 44 preferably include a lens which permits a magnified view of the keypad 46 when a user looks through the pane 44 from a certain angle and yet provides a distorted view of the keypad 46 when viewed from other angles. FIG. 7 shows a schematic view of an ATM 56 having a keypad 46 and an enclosure device 10 according to the present invention. The device 10 is provided with a security pane 44 including magnifying lens such as, for example, a fresnel lens. Above the enclosure device 10 there is defined a viewing corridor 58 the cross-sectional dimensions of which correspond substantially to those of the viewing aperture 16. A person viewing the keypad 46 through the pane 44 along an axis 60 lying within the corridor 58 and substantially perpendicular to the security pane 44 and keypad 46 will be able to view a magnified image of the full keypad as illustrated in FIG. 8. Should a person attempt to view the along an axis 62 which is not perpendicular to the lens and keypad and which extends out of the viewing corridor is presented with a distorted image of the keypad 46. Examples of the type of view which may be observed are shown in FIGS. 9 and 10. In FIG. 9 the lower portion of the keypad 46 is obscured including the 0 key, while in FIG. 10 the upper portion the keypad 46 including the 1, 2 and 3 keys is obscured.

The security pane 44 may, for example have a thickness of around 5 mm. The security pane may be comprised of a fresnel lens having this thickness. In an alternative embodiment, the security pane 44 may comprise a fresnel lens having a thickness of less than 5 mm which is mounted to, attached to, or carried by a member of the appropriate supplemental thickness. For example, the lens may be mounted to a piece of substantially transparent toughened plastics or glass material. In an alternative embodiment, the fresnel lens may be sandwiched between two such glass or plastics members.

Referring now to FIGS. 11 to 14 there is shown an alternative embodiment of a security enclosure device generally designated 100. The enclosure device 100 is configured for use with point of sale PIN entry devices 102 of the type shown in FIG. 13. The device includes a base 104 and a visor 106. The base 104 includes a floor 107 and two upstanding walls 108. The visor 106 includes a curved face portion 110 and spaced arms 112. The face portion 110 includes a viewing aperture 114 to which is mounted a curved security pane 116. The curving of the face portion 110, and the security pane 116 provides better hand access for the user and reduces the possibility of the user contacting the security pane with their knuckles, and furthermore reduces glare which may be caused by ambient lighting in the vicinity of the device 100. The visor 106 is pivotally mounted to the base 104 and is movable relative to the base 104 as indicated by arrow 118 on FIG. 14.

In the embodiment shown, the base 104 is formed from a substantially planar sheet of material, such as for example mild steel, with the interface between the floor 106 and walls 108 being defined by folds 120. The floor 106 is provided with a plurality of folded tabs 122,124,126 which, in use, serve to locate the PIN entry device 102 on the base portion 104. The tabs 122,124 126 are defined either by folded portions of the edge of the floor 106, or by folded out portions of the body of the floor 106. The tabs 122,124,126 are provided with protective covers 128. It will be appreciated that alternative tab configurations may be provided to accommodate different sizes and shapes of PIN entry device 102. The underside 130 of the floor 107 is provided with pivotable joint 132 which permits the enclosure device 100 to be mounted to a post or pole 134 provided on a shop counter or the like. The joint 132 permits the enclosure device 100 to be pivoted as indicated by arrow 136 of FIG. 14. The enclosure device is also rotatable on the post or pole 134 as indicated by arrow 137. The joint 132 comprises a bracket 138 and a tubular member 140 which are connected to one another by a pin arrangement 142.

The underside 130 of the floor 106 is further provided with a forwardly projecting handle 144 which may be manipulated by a user to move the enclosure 100 to a desired inclination.

The arms 112 of the visor 106 are pivotably mounted to the walls 108 by the provision of pinned links 146 which pass through both the arms 112 and the walls 108. The arms 112 may preferably be manufactured from the same material as the base portion 104. The face portion 110 may be formed integrally with the arms 112. Alternatively, the face portion 110 may be defined by a separate component or assembly of components to which the arms 112 may be attached.

The security pane 116 is curved to substantially the same degree as the face portion 110. The security pane 116 may be preformed to the desired curve. In an alternative embodiment, the security pane 116 may be flexible and assumes the desired curve upon insertion into a curved track or slot of visor 106 as indicated by arrow 148 of FIG. 14. The pane 116 is resiliently flexible and naturally assumes a flat configuration. It will be understood that the natural urge for the pane 116 to resume its flat configuration when bent into a curve may be exploited to retain the pane 116 within the visor 106. In such an embodiment the security pane 116 may comprise a fresnel lens manufactured from a plastics material such as, for example, acrylic or PVC, and have a thickness of around 0.4 mm. This feature makes it relatively straightforward for the security pane 116 to be removed and replaced. By curving the security pane 116 to make it conform to the curved shape of the visor 106, it will be understood that the strength and resilience to deformation of pane 116 from externally applied forces is improved.

In use, the visor 106 is pivotable between an open position shown in FIGS. 11 and 13, and a closed position shown in FIGS. 12 and 14. In the closed position, the viewing aperture 114 and security pane 116 overlie the keypad 150 of the PIN entry device 102 such that the keypad 150 can be viewed by a user therethrough. An access aperture 152 which permits a user to reach the keypad 150 is defined between the forward edges of the base and visor 104,106. A further access aperture 154 is defined between the rear edges of the base and visor 104,106. This further access aperture enables a counter assistant to insert a card onto a slot 156 of the PIN entry device 102 prior to a user inputting their PIN to the keypad 150. The card may, for example, be a credit or debit card, or a loyalty card. The walls 108 are provided with stop pins 158 which limit the forward movement of the visor 106 relative to the base 104.

A user may choose not to view the keypad 150 through the viewing aperture 114 and security pane 116 and hence move the visor 106 to the open position.

Referring now to FIGS. 15 and 16, there is shown an alternative embodiment of a security enclosure device generally designated 160. Features common to the device 100 described with reference to FIGS. 11 to 14 are identified with like reference numerals. The device 160 differs in that the upstanding walls 108 of the base 104 are provided with a cut-out portion indicated by arrow 162 at their front edge. The term “front” refers to the region of the device 160 which faces a user who intends to enter a PIN to the PIN entry device 102. The cut out portions 162 are provided so as to accommodate a transverse slot 164 of the PIN entry device 102 which may, in use, require a card 166 to be swiped therethrough. Optionally, the arms 112 of the visor 106 may be extended in a forward direction, as indicated by broken line 168 of FIG. 14, so as to replace the material removed from the walls 108. In such an embodiment, the visor 106 can be pivoted rearwardly to a position where the slot 164 is accessible to permit a card 166 to be swiped, before being pivoted forward for subsequent entry of a PIN to the PIN entry device.

Referring now to FIGS. 17 to 24 there is shown an alternative embodiment of a security enclosure device generally designated 170. Features common to the device 100 described with reference to FIGS. 11 to 14, and the device 160 described with reference to FIGS. 15 and 16 are identified with like reference numerals, and the device 170 is operable in the same manner as hereinbefore described.

The visor includes 106 a curved face portion 110 and spaced arms 112. The face portion 110 includes a viewing aperture 114 to which is mounted a curved security pane 116. Surrounding the viewing aperture 114 there is provided a curved outer bezel 172 and a curved inner bezel 174. The outer bezel 172 is removable attachable to the visor 106 and is receivable in a recess 176 of the face portion 110 which surrounds the viewing aperture 114. The outer bezel 172 may be used to brand the device 170 in accordance with a given retailer or financial service provider. The outer bezel 172 may be retained to the visor 106 by the interengagement of projections of the outer bezel 172 with corresponding slots or apertures 178 provided in the recess 176 of the face portion 110.

The inner bezel 174 is attachable to the curved inner surface of the face portion 110 of the visor 106. The curved side walls 180 of the inner bezel 174 are provided with barbed tabs 182 which are receivable in corresponding slots or apertures 184 of the visor 106. The inner bezel 174 is further provided with a stop projection 186 and opposed guide projections 188 which project from end walls 190 of the inner bezel 174. The end walls 190 extend between the curved side walls 180 of the inner bezel 174. When the inner bezel 174 is fitted to the visor 106, the stop and guide projections 186,188 rest against the inner surface of the face portion 110 of the visor 106, and curved guide 192 into which the security pane 116 may be inserted is defined between the inner bezel 174 and the inner surface of the face portion 110 of the visor 106. The security pane 116 may be inserted and removed from the curved guide 192 through an opening 194 provided between the guide projections 188. The stop projection 186 acts to limit the distance by which the security pane 116 may be inserted and to ensure its correct positioning.

The face portion 110 of the visor 106 is further provided with upper and lower grip portions 196 which may be gripped by a user when pivoting the visor 106. The visor 106, and inner and outer bezels 172,174 may advantageously be manufactured by an injection moulding operation from a plastics material.

The base 104 includes a floor 107 and two upstanding walls 108. The floor 107 includes an extension 198 which projects in the direction of a user of the device 170. The extension 198 may be utilised in the same manner as the handle 144 of the enclosure device 100 of FIGS. 11 to 14 to alter the inclination of the base 104 relative to the mounting pole 134. The inner face 200 of each upstanding wall 108 is provided with fore and aft stop projections 202,204 which, in use, limit the pivotal movement of the visor 106 relative to the base 104 by contacting the arms 112 of the visor 106.

The base 104 is further provided with a removable seat or plate 204 to which a PIN entry device 102 may be mounted. The use of a removable plate 204 permits a base 104 of a standard configuration to accommodate differing PIN entry devices 102, with differing plates being available for different PIN entry devices. The plate 204 is releasably securable to the base by the provision of a clip on the underside thereof which is attachable to a rear edge 206 of the floor 107 of the base 104. The plate 204 comprises a floor 208 and opposed walls 210 which are configured to locate a PIN entry device 102 therebetween. The base 104 and plate 204 may be manufactured by a moulding operation from a plastics material.

It will be understood that the curved security panes 116 of the devices 100, 160, 170 described with reference to FIGS. 11 to 24 operate in the same manner to distort the view of the keypad by an unauthorised viewer as the security pane 16 described with reference to the device 10 described with reference to FIGS. 1 to 10.

The security pane may take forms other than that of just a lens. For example, the pane may additionally have retained therein or thereupon an image through which the keypad may be viewed by a user, but which occludes the view of the keypad from viewing angles other than those utilised by a legitimate user of the keypad.

For example, the security pane may include a holographic image which is hidden to a legitimate user of the device. In a further embodiment the security pane may include a plurality of windows aligned with keys of the keypad. Each window may include a lens, retained image or a combination of the two. The lens may optionally be tinted, coloured, frosted and/or polarised in order to prevent the unauthorised viewing of the keypad therethrough.

1. A keypad security device comprising an enclosure having a viewing aperture and an access aperture, the enclosure at least partially surrounding a keypad such that the keypad is viewable through the viewing aperture and accessible by a user through the access aperture, the viewing aperture including a security pane arranged so as to permit the keypad to be viewed clearly from the point of view of a user of the keypad and to prevent the keypad from being viewed from the point of view of a person other than the user, wherein the security pane is curved and comprises a flexible refractive lens.

2. A keypad security device as claimed in claim 1, wherein the pane is curved outwardly with respect to the keypad.

3. A keypad security device as claimed in claim 1, wherein the security pane is pivotably mounted to the enclosure.

4. A keypad security device as claimed in claim 3, wherein the security pane is pivotable between an operative position whereupon it overlies the keypad, and a non-operative position whereupon the pane does not overlie the keypad.

5. A keypad security device as claimed in claim 3, wherein the enclosure comprises a base having opposed walls, and a visor carrying the security pane which is pivotably mounted to the base.

6. A keypad security device as claimed in claim 5 wherein the visor is pivotably mounted to at least one of the opposed walls.

7. A keypad security device as claimed in claim 5 wherein the viewing aperture is provided in the visor.

8. A keypad security device as claimed in claim 5 wherein the security pane is mounted to the visor in a removable manner.

9. A keypad security device as claimed in claim 8 wherein the security pane is mounted to a slot of the visor in a removable manner.

10. A keypad security device as claimed in claim 9 wherein said slot is defined between the visor and a member mounted to the visor.

11. A keypad security device as claimed in claim 5, wherein the base is configured to receive and retain thereupon a body having a keypad.

12. A keypad security device as claimed in claim 11 wherein the base includes a removable seat, said seat being configured to receive and retain thereupon a body having a keypad.

13. A keypad security device as claimed in claim 1, wherein the radius of curvature of the security pane is in the range of 100 mm to 500 mm.

14. A keypad security device as claimed in claim 13, wherein the radius of curvature is in the region of 100 mm to 200 mm.

15. A keypad security device as claimed in claim 14, wherein the radius of curvature is in the region of 110 mm to 150 mm.

16. A keypad security device as claimed in claim 1, wherein the lens is a fresnel lens.

17. A keypad security device as claimed in claim 16, wherein the pitch of the grooves of the fresnal lens is in the range of 0.01 mm to 0.06 mm.

18. A keypad security device as claimed in claim 17, wherein the pitch of the grooves of the fresnel lens is in the range of 0.02 mm to 0.05 mm.

19. A keypad security device as claimed in claim 18, wherein the grooves of the fresnel lens have a pitch of around 0.04 mm.

20. A keypad security device as claimed in claim 1, wherein the lens has a thickness of between 0.4 mm and 1.5 mm.

21. A keypad security device as claimed in claim 20, wherein the lens has a thickness of around 1 mm.

22. A keypad security device as claimed in any preceeding claim, wherein the lens has a refractive index of between 1.3 and 1.8.

23. A keypad security device as claimed in claim 22, wherein the lens has a refractive index of between 1.4 and 1.7.
